(19) United States
(12) Patent Application Publication
(10) Pub. No.: US 2019/0346310 A1
(43) Pub. Date: Nov. 14, 2019

(54) METHOD OF IMPROVING THE ACCURACY OF THE TEMPERATURE MEASUREMENT OF THERMAL/INFRARED ARRAY SENSOR

(71) Applicant: Panasonic Automotive Systems Company of America, Division of Panasonic Corporation of North America, Peachtree City, GA (US)

(72) Inventor: JIN WOO JUNG, JOHNS CREEK, GA (US)

(73) Assignee: Panasonic Automotive Systems Company of America, Division of Panasonic Corporation of North America

(21) Appl. No.: 16/407,047

(22) Filed: May 8, 2019

Related U.S. Application Data
(60) Provisional application No. 62/668,287, filed on May 8, 2018.

(51) Int. Cl. G01J 5/24; G01J 5/00

(52) U.S. Cl. CPC G01J 5/24; G01J 2005/106; G01J 5/0003

(57) ABSTRACT

An arrangement for sensing temperatures on a surface includes a thermal/infrared array sensor having a field of view. The thermal/infrared array sensor is positioned such that the surface is within the field of view. A benchmark object has a known temperature. The benchmark object is disposed within the field of view of the thermal/infrared array sensor. An electronic processor is communicatively coupled to the thermal/infrared array sensor and receives a signal from the thermal/infrared array sensor. The signal includes a temperature measurement of the surface and a temperature measurement of the benchmark object. A difference between the temperature measurement of the benchmark object and the known temperature of the benchmark object is calculated. A temperature of the surface is calculated based on the temperature measurement of the surface and the difference between the temperature measurement of the benchmark object and the known temperature of the benchmark object.

### CROSS-REFERENCE TO RELATED APPLICATIONS

This application claims the benefit of U.S. Provisional Application No. 62/668,287, filed on May 8, 2018, which the disclosure of which is hereby incorporated by reference in its entirety for all purposes.

### FIELD OF THE INVENTION

The disclosure relates to a thermal/infrared array sensor in a motor vehicle.

### BACKGROUND OF THE INVENTION

A thermal/infrared array sensor is a device that can measure/detect temperature of an area. One advantage of using this technology is that it can detect/measure temperature without actually touching the object itself. This technology has many potential applications, such as intelligent temperature control, checking the health status of people, monitoring the temperature inside of a vehicle or building, etc.

However, one major disadvantage of this technology is that the temperature measurement captured through the sensor can have an error of a few degrees. That is, although this technology has relatively good sensitivity or “noise equivalent temperature difference (NETD),” which can provide a quite accurate relative temperature difference between arrays/pixels (typically 1/10^{th} of degree Celsius), the absolute temperature of each array is not so accurate (e.g., plus-minus a few degrees Celsius). FIGS. 1a-b illustrate an example wherein the temperature measurement provided by a thermal/infrared array sensor is two degrees Celsius higher than the actual temperature in each of sixteen cells of a four by four array of cells. More particularly, FIG. 1a is an array of the actual temperatures (e.g., the true temperatures of the area of the interest which are not from the array sensor) in each of sixteen cells of a four by four array of cells. FIG. 1b is an array of example temperature measurements provided by a prior art thermal/infrared array sensor in each of the sixteen cells of the four by four array of cells of FIG. 1b.

FIG. 2 is an array having the same relative differences in array values as compared to the arrays of FIGS. 1a-b. Note that the absolute temperature values have errors in the example of FIG. 1b. However, the relative differences within a given array between the values of the cells in each of the arrays of FIGS. 1a-b and 2 are the same. That is, it can easily be seen that each of the three arrays have the same relative differences between cell values within the array. Specifically, adding 20 to each value in the array of FIG. 2 yields the array values of FIG. 1a, and adding 22 to each value in the array of FIG. 2 yields the array values of FIG. 1b.

The above-illustrated accuracy problem prevents a known thermal/infrared array sensor from being used in applications that require accurate absolute temperature measurement. For instance, using a known thermal/infrared array sensor to detect whether a person has a fever or not would be difficult due to the sensor's inaccuracy, although the person may be in an environment where using a thermometer or similar device would be too dangerous or impractical, such as the inside of a moving vehicle.

### SUMMARY

The present invention may overcome the problems of the prior art described above by providing one cell (or more than one cell) of the measured array with a known temperature. The temperatures of the one cell with the known temperature and other nearby cells in an array are measured, The measurement error of the one cell with the known temperature may be calculated and used to determine and correct the measurement error of the other cells in the array.

In one embodiment, the invention comprises an arrangement for sensing temperatures on a surface, including a thermal/infrared array sensor having a field of view. The thermal/infrared array sensor is positioned such that the surface is within the field of view. A benchmark object has a known temperature. The benchmark object is disposed within the field of view of the thermal/infrared array sensor. An electronic processor is communicatively coupled to the thermal/infrared array sensor and receives a signal from the thermal/infrared array sensor. The signal includes a temperature measurement of the surface and a temperature measurement of the benchmark object. A difference between the temperature measurement of the benchmark object and the known temperature of the benchmark object s calculated. A temperature of the surface is calculated based on the temperature measurement of the surface and the difference between the temperature measurement of the benchmark object and the known temperature of the benchmark object.

In another embodiment, the invention comprises a method of sensing temperatures on a surface, including positioning a thermal/infrared array sensor such that the surface is within a field of view of the thermal/infrared array sensor. A benchmark object having a known temperature is disposed within the field of view of the thermal/infrared array sensor. A signal is received from the thermal/infrared array sensor. The signal includes a temperature measurement of the surface and a temperature measurement of the benchmark object. A difference between the temperature measurement of the benchmark object and the known temperature of the benchmark object is calculated. A temperature of the surface is calculated based on the temperature measurement of the surface and the difference between the temperature measurement of the benchmark object and the known temperature of the benchmark object.

In yet another embodiment, the invention comprises an infotainment system for a motor vehicle. The infotainment system includes a thermal/infrared array sensor having a field of view. The thermal/infrared array sensor is positioned such that a surface is within the field of view. A benchmark object has a known temperature. The benchmark object is disposed within the field of view of the thermal/infrared array sensor. An electronic processor is communicatively coupled to the thermal/infrared array sensor and receives a signal from the thermal/infrared array sensor. The signal includes a temperature measurement of the surface and a temperature measurement of the benchmark object. A difference between the temperature measurement of the benchmark object and the known temperature of the benchmark object is calculated. A temperature of the surface is calculated based on the temperature measurement of the surface and the difference between the temperature measurement of the benchmark object and the known temperature of the benchmark object,

### BRIEF DESCRIPTION OF THE DRAWINGS

A better understanding of the present invention will be had upon reference to the following description in conjunction with the accompanying drawings.

FIG. 1a is an array of the actual temperatures in each of sixteen cells of a four by four array of cells.

FIG. 1b is an array of example temperature measurements provided by a prior art thermal/infrared array sensor in each of the sixteen cells of the four by four array of cells of FIG. 1b.

FIG. 2 is an array having the same relative differences in array values as compared to the arrays of FIGS. 1a-b.

FIG. 3 is a perspective view of one embodiment of a thermal/infrared array sensor arrangement of the present invention.

FIG. 4 is a flow chart of one embodiment of a method of the present invention for sensing temperatures on a surface.

### DETAILED DESCRIPTION OF THE PREFERRED EMBODIMENTS

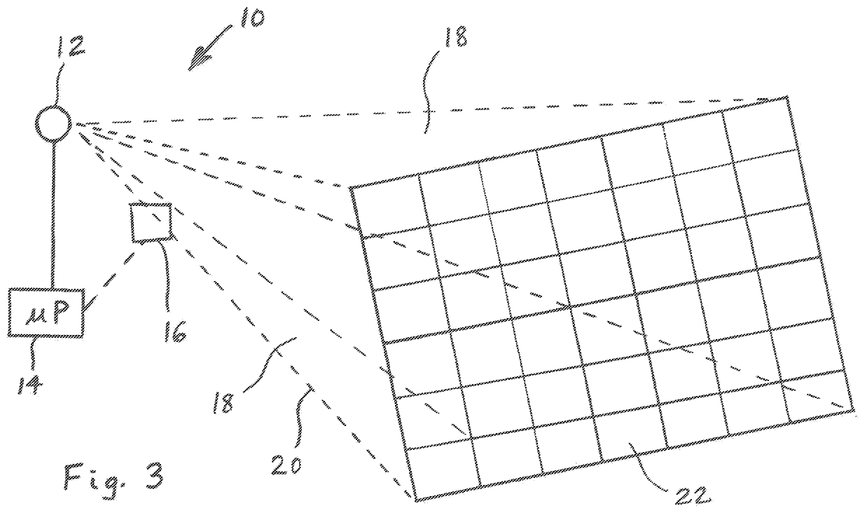

FIG. 3 illustrates one embodiment of a thermal/infrared array sensor arrangement 10 of the present invention, including a thermal/infrared array sensor 12, an electronic processor 14 and a benchmark object 16 having a known temperature. Sensor 12 may be in wired or wireless communication with processor 14. Processor 14 may or may not be in communication with benchmark object 16 for regulating the temperature of object 16.

Benchmark object 16 may be within a field of view 18 of sensor 12. In some embodiments, benchmark object 16 straddles, overlaps or intersects a boundary 20 of the field of view of sensor 12 such that a portion of benchmark object 16 is out of the field of view 18 of sensor 12, and thus more of the field of view 18 of sensor 12 may be used for sensing the temperature of the surface of interest 22.

Surface of interest 22 is shown in FIG. as being divided into a seven cell by six cell array within the field of view 18 of sensor 12. Benchmark object 16 may be disposed on, or may be coplanar with, surface of interest 22. Alternatively, benchmark object 16 may be disposed above surface of interest 22, and may partially eclipse surface of interest 22 within the field of view 18 of sensor 12.

Sensor 12 may include an array of pixels. One or more of the pixels of the sensor may sense the object 16, the temperature of which can be known and available to the system that does the temperature correction. As shown in FIG. 3, the object 16 with the known temperature is disposed within the field of view 18 of the sensor 12.

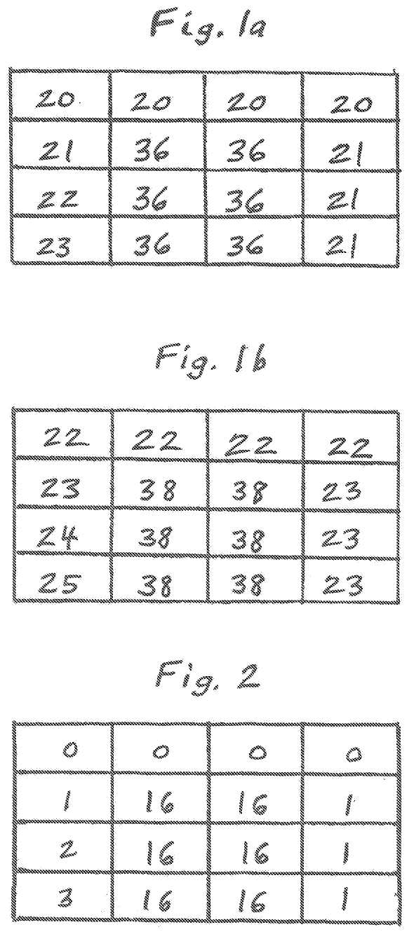

By combining the facts that (i) the temperature value of the known-temperature object 16 is available to the system and (ii) the relative differences between the temperature measurements of the cells or pixels in a same array are rather accurate (e.g., typically 1/10^{th} of degree Celsius), the accurate absolute temperature for each cell in the entire array can be calculated. The procedure and an example for calculating the accurate temperature (or correcting temperature) may be described with reference to the arrays of FIGS. 1a-b. Assuming that the cell in the bottom left corner of the array is the cell with a known temperature value (i.e., 23 in FIG. 1a), the actual correct temperature of every other cell in the array can be calculated based on the temperature measurements in the array of FIG. 1b, which is described below.

During use, the temperature measurement (using sensor 12) of the object 16 in the cell in the lower left corner of the array may be a measurement of 25 (which is in error), as shown in FIG. 1b. However, because it is known that the correct temperature of this cell is actually 23, it may be determined that all of the measurements in the array of FIG. 1b are too high by a value of 2 (i.e., 25−23). Thus, by subtracting the value of 2 from each value in FIG. 1b, the correct temperature values of FIG. 1a may be calculated, and accurate absolute temperature values are thereby achieved.

The location, connection mechanism and type of the known-temperature object 16 can be in any form, as long as object 16 can provide consistent temperature values to the system that performs the temperature correction. One example of such an object 16 is a thermistor. The system that performs the temperature correction (e.g., processor 14 in FIG. 3) can be anything as long as it (i) can obtain the sensor readings and the actual temperature of the reference object, and (ii) performs the temperature correction. The system that performs the temperature correction can be included in an infotainment system and integrated with the sensor and with the known-temperature object.

The known-temperature object 16 can be positioned so that it eclipses or is superimposed over only one cell of the array, and only one pixel (or the number of pixels associated with one cell) of the sensor sees the object, since that cell of the array (and corresponding pixel(s)) is used only to sense the known temperature of the object, and that pixel(s) is not used to scan the area or surface of interest. However, such a limitation is not necessary for this invention to work properly, and other positions of object 16 are within the scope of the invention.

The example illustrated in the drawings is directed to the case where the absolute temperature value readings are corrected by offsetting the temperature values. However, as long as the temperature values can be generated and corrected by using the known temperature value from a known-temperature object and sensor readings, there may be no limit within the scope of the invention on which form/value of sensor reading is provided by the sensor. For example, the form/value of the sensor reading provided by the sensor can be absolute or relative, and may not even be a temperature reading. Nor is there a limitation within the scope of the invention on how the correct temperature values are eventually obtained. The invention may involve using an object with a known temperature and combine that information with the inaccurate array sensor readings to get the accurate (relatively) temperatures.

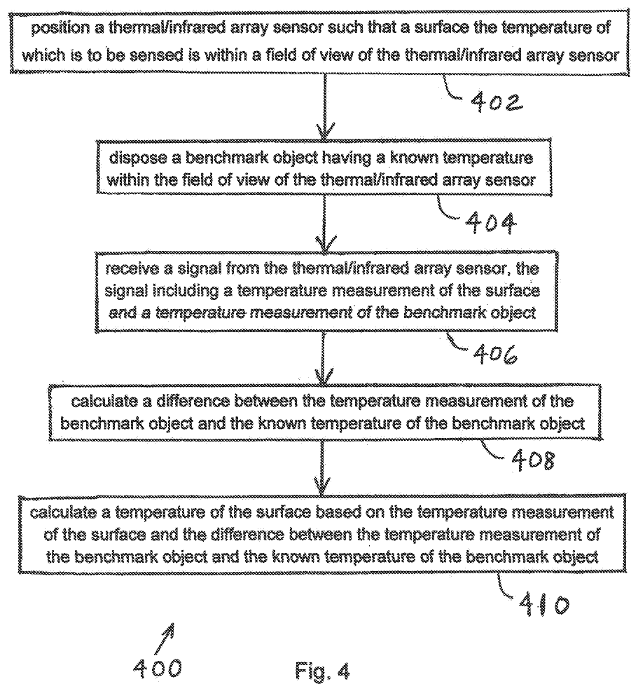

FIG. 4 illustrates one embodiment of a method 400 of the present invention for sensing temperatures on a surface. In a first step 402, a thermal/infrared array sensor is positioned such that the surface is within a field of view of the thermal/infrared array sensor. For example, sensor 12 may be positioned such that surface of interest 22 is within field of view 18 of sensor 12.

In a next step 404, a benchmark object having a known temperature is disposed within the field of view of the thermal/infrared array sensor. For example, benchmark object 16 having a known temperature may be within a field of view 18 of sensor 12.

Next, in step 406, a signal is received from the thermal/infrared array sensor. The signal includes a temperature measurement of the surface and a temperature measurement of the benchmark object. For example, processor 14 may receive a signal from sensor 12 wherein the signal includes a temperature measurement of surface 22 and a temperature measurement of benchmark object 16.

In step 408, a difference between the temperature measurement of the benchmark object and the known temperature of the benchmark object is calculated. For example, a temperature measurement (using sensor 12) of the object 16 in the cell in the lower left corner of the array may be a measurement of 25 (which is in error), as shown in FIG. 1b. However, because it is known that the correct temperature of this cell is actually 23, a difference between the temperature measurement of the benchmark object (25) and the known temperature of the benchmark object (23) is calculated as a value of 2 (i.e., 25−23).

In a final step 410, a temperature of the surface is calculated based on the temperature measurement of the surface and the difference between the temperature measurement of the benchmark object and the known temperature of the benchmark object. For example, by subtracting the value of 2 from each value in FIG. 1b, the correct temperature values of FIG. 1a may be calculated, and accurate absolute temperature values are thereby achieved.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. An arrangement for sensing temperatures on a surface, the arrangement comprising:
a thermal/infrared array sensor having a field of view, the thermal/infrared array sensor being positioned such that the surface is within the field of view;
a benchmark object having a known temperature, the benchmark object being disposed within the field of view of the thermal/infrared array sensor; and
an electronic processor communicatively coupled to the thermal/infrared array sensor and configured to:
receive a signal from the thermal/infrared array sensor, the signal including a temperature measurement of the surface and a temperature measurement of the benchmark object;
calculate a difference between the temperature measurement of the benchmark object and the known temperature of the benchmark object; and
calculate a temperature of the surface based on the temperature measurement of the surface and the difference between the temperature measurement of the benchmark object and the known temperature of the benchmark object.

2. The arrangement of claim 1 wherein the signal from the thermal/infrared array sensor includes a plurality of temperature measurements of the surface, each of the temperature measurements corresponding to a different, respective portion of the surface, the electronic processor being configured to calculate a respective temperature of each of the portions of the surface based on the temperature measurements of the portions of the surface and the difference between the temperature measurement of the benchmark object and the known temperature of the benchmark object.

3. The arrangement of claim 1 wherein the benchmark object comprises a thermistor.

4. The arrangement of claim 1 wherein the electronic processor is configured to calculate a temperature of the surface by subtracting the difference between the temperature measurement of the benchmark object and the known temperature of the benchmark object from the temperature measurement of the surface.

5. The arrangement of claim 1 wherein the benchmark object intersects a boundary of the field of view of the sensor.

6. The arrangement of claim 1 wherein the benchmark object is in a corner of the field of view of the sensor.

7. The arrangement of claim 1 wherein the arrangement is included in an infotainment system or advanced driver-assistance system of a motor vehicle.

8. A method of sensing temperatures on a surface, the method comprising:
positioning a thermal/infrared array sensor such that the surface is within a field of view of the thermal/infrared array sensor;
disposing a benchmark object having a known temperature within the field of view of the thermal/infrared array sensor;
receiving a signal from the thermal/infrared array sensor, the signal including a temperature measurement of the surface and a temperature measurement of the benchmark object;
calculating a difference between the temperature measurement of the benchmark object and the known temperature of the benchmark object; and
calculating a temperature of the surface based on the temperature measurement of the surface and the difference between the temperature measurement of the benchmark object and the known temperature of the benchmark object.

9. The method of claim 8 wherein the signal from the thermal/infrared array sensor includes a plurality of temperature measurements of the surface, each of the temperature measurements corresponding to a different, respective portion of the surface, the method further comprising calculating a respective temperature of each of the portions of the surface based on the temperature measurements of the portions of the surface and the difference between the temperature measurement of the benchmark object and the known temperature of the benchmark object.

10. The method of claim 8 wherein the benchmark object comprises a thermistor.

11. The method of claim 8 further comprising calculating a temperature of the surface by subtracting the difference between the temperature measurement of the benchmark object and the known temperature of the benchmark object from the temperature measurement of the surface.

12. The method of claim 8 wherein the benchmark object intersects a boundary of the field of view of the sensor.

13. The method of claim 8 wherein the benchmark object is in a corner of the field of view of the sensor.

14. The method of claim 8 wherein the method is performed within an infotainment system or advanced driver-assistance system of a motor vehicle.

15. An infotainment system for a motor vehicle, the infotainment system comprising:
a thermal/infrared array sensor having a field of view, the thermal/infrared array sensor being positioned such that a surface is within the field of view;
a benchmark object having a known temperature, the benchmark object being disposed within the field of view of the thermal/infrared array sensor; and
an electronic processor communicatively coupled to the thermal/infrared array sensor and configured to:
receive a signal from the thermal/infrared array sensor, the signal including a temperature measurement of the surface and a temperature measurement of the benchmark object;
calculate a difference between the temperature measurement of the benchmark object and the known temperature of the benchmark object; and
calculate a temperature of the surface based on the temperature measurement of the surface and the difference between the temperature measurement of the benchmark object and the known temperature of the benchmark object,

16. The infotainment system of claim 15 wherein the signal from the thermal/infrared array sensor includes a plurality of temperature measurements of the surface, each of the temperature measurements corresponding to a different, respective portion of the surface, the electronic processor being configured to calculate a respective temperature of each of the portions of the surface based on the temperature measurements of the portions of the surface and the difference between the temperature measurement of the benchmark object and the known temperature of the benchmark object.

17. The infotainment system of claim 15 wherein the benchmark object comprises a thermistor.

18. The infotainment system of claim 15 wherein the electronic processor is configured to calculate a temperature of the surface by subtracting the difference between the temperature measurement of the benchmark object and the known temperature of the benchmark object from the temperature measurement of the surface.

19. The infotainment system of claim 15 wherein the benchmark object ntersects a boundary of the field of view of the sensor.

20. The infotainment system of claim 15 wherein the benchmark object is in a corner of the field of view of the sensor.
